(19) United States
(12) Patent Application Publication
(10) Pub. No.: US 2026/0063930 A1
(43) Pub. Date: Mar. 5, 2026

(54) Adaptive Multi-Array Funnel System for Dynamic Wavelength Compression Using Sensor-Embedded Metasurfaces

(71) Applicant: Joseph Carlo Pastrana, Sneads Ferry, NC (US)

(72) Inventor: Joseph Carlo Pastrana, Sneads Ferry, NC (US)

(21) Appl. No.: 19/353,263

(22) Filed: Oct. 8, 2025

(51) Int. Cl. G02F 1/01; B82Y 20/00; G02B 1/00; G02F 1/23

(52) U.S. Cl. CPC G02F 1/0128; B82Y 20/00; G02B 1/002; G02F 1/0121; G02F 1/23; G02F 2201/58; G02F 2202/30

(57) ABSTRACT

A system comprising multiple rotating and shape-adjustable funnel structures made with glass-type materials layered with metamaterials and/or metasurface materials with embedded surface sensors to generate different wavelengths as each funnel compress, stretch, or redirect incoming light wavelengths based on the geometry of the funnels and the sensors feedback and wherein the dynamic optical system manipulates light in real time and is operated by an AI algorithm to optimize funnel behavior for specific spectral outputs.

### CROSS-REFERENCE TO RELATED APPLICATIONS

Not applicable to this application

### FEDERALLY SPONSORED RESEARCH OR DEVELOPMENT

Not applicable to this application

### SEQUENCE LISTING, A TABLE, OR A COMPUTER PROGRAM LISTING

Not applicable to this application

### INCORPORATION BY REFERENCE OF MATERIAL SUBMITTED, COMPACT DISC APPENDIX

Not applicable to this application

### STATEMENT REGARDING PRIOR DISCLOSURES BY THE INVENTOR

Not applicable to this application

### BACKGROUND OF THE INVENTION

The technical field of the invention relates to existing systems for wavelength compression that rely on static geometries or limited spectral control. This invention introduces a dynamic, shape-adjustable funnel structures layered with metamaterial and/or metasurface materials with embedded surface sensors, arranged in a multi-array configuration, for the purpose of real-time spectral modulation and compression. Accordingly, the invention provides a dynamic, real-time reconfigurability of optical behavior, which significantly enhances the effectiveness, precision, and adaptability of light-based systems for applications such as digital communications and spectral control.

### DESCRIPTION OF PRIOR ART

Not applicable to this application

### BRIEF SUMMARY OF THE INVENTION

A system comprising multiple rotating and shape-adjustable funnel structures made of glass-type materials layered with metamaterial/metasurface materials with embedded surface sensors to generate different wavelengths as each funnel compress, stretch, or redirect incoming light wavelengths based on the geometry of the funnels and the sensors feedback and wherein the dynamic optical system manipulates light in real time and is operated by an AI algorithm to optimize funnel behavior for specific spectral outputs.

### BRIEF DESCRIPTION OF THE SEVERAL VIEWS OF THE DRAWINGS

Not applicable to this application

### DETAILED DESCRIPTION OF THE INVENTION

The invention, an adaptive multi-array funnel system for dynamic wavelength compression, is comprised of multiple rotating and shape-adjustable funnel structures made of glass-type materials layered with metamaterial/metasurface materials and embedded with surface sensors to generate different wavelengths as each funnel compress, stretch, or redirect incoming light wavelengths based on the geometry of the funnels and the sensors feedback and wherein the dynamic optical system manipulates light in real time and is operated by an AI algorithm to optimize funnel behavior for specific spectral outputs. Each funnel dynamically modulates its geometry.

For simplicity, the invention, an adaptive multi-array funnel system for dynamic wavelength compression, is abbreviated in this document as the “system”.

The said system comprising of multiple rotating and shape-adjustable funnel structures layered with metamaterial/metasurface materials and embedded surface sensors to generate different wavelengths as each funnel compress, stretch, or redirect incoming light wavelengths based on the geometry of the funnels and where each funnel dynamically modulates its geometry independently for compression optimization, adaptive feedback, photonic computing, hyperspectral imaging, and quantum optics.

The system's architecture is comprising of: array of funnels forming a grid or matrix of funnel-shaped waveguides wherein each funnel can rotate independently, morph its geometry per diameter, curvature, taper, be tuned to specific wavelength ranges, sensor-embedded surfaces, each funnel lined with metamaterial/metasurface materials and embedded with sensors that detect incoming light properties intensity, phase, polarization, adjust local refractive index or surface plasmon response, communicate with neighboring funnels for coordinated modulation, control layer via a central processor or neural network governs the behavior of each funnel based on input light and desired output through route light through specific funnels, applying compression algorithms, and adapting in real time to environmental changes.

The invention comprises of a rotating funnel-shaped structure made of metamaterial/metasurface layered materials embedded with surface sensors. Light enters the wide end of the funnel and travels toward the narrow tip. As it moves through the funnel, several mechanisms could compress or modify the wavelengths per shape modulation, wherein the funnel can dynamically change its curvature, diameter, and angle of rotation. These geometric changes alter the path length and confinement of light, enabling wavelength compression or stretching.

Surface sensors could be photonic or plasmonic sensors that interact with incoming light. Depending on their configuration, they could detect and respond to specific wavelengths, apply localized refractive index changes, induce phase shifts or polarization changes.

The rotation of a funnel creates centrifugal forces that influence light propagation, enable Doppler-like effects to shift wavelengths, and allow for angular momentum transfer to photons per optical vortex generation. The added rotation function and speed of the rotation of a funnel influences the spectral output, shifting intensity peaks and modulating wavelength distribution. Furthermore, when the funnel's speed rotation is accelerated, higher speeds introduce sinusoidal modulation across the spectrum, causing intensity fluctuations in the mid-range wavelengths while at low speeds, the output remains stable and centered around the funnel's geometric bias.

The wavelength compression works via: Adiabatic Tapering as light moves through the narrowing funnel, its mode profile is squeezed, similar to how waveguides compress light and reduce the effective wavelength in the medium.

Likewise, the wavelength compression works through: Metasurface Control, wherein the surface sensors could act as a metasurface, dynamically tuning the refractive index or phase delay across the funnel walls to compress or reshape the light.

Similarly, the wavelength compression works through: Nonlinear Optical Effects, wherein if the metasurface material is designed to support nonlinear interactions (e.g., second-harmonic generation), the funnel could convert incoming light to shorter wavelengths.

Moreover, the wavelength compression can also work through: Photonic Crystal Behavior, wherein the funnel could mimic a photonic crystal with tunable bandgaps, selectively allowing or blocking certain wavelengths based on its geometry.

Additionally, the system utilizes a shape-morphing funnel configuration for the generation of real-time spectral modulation and specific spectral outputs. As an example of shape-morphing funnel configuration, wherein a funnel's wall changes its angle, is a funnel utilizing the principle of Iris-Type diaphragm, where a mechanism of overlapping blades makes it possible for the funnel to change its wall's angle, and thus, operating like a camera's mechanical aperture which is also based on the Iris-Type diaphragm design.

The Iris-Type diaphragm mechanism could work by adjusting the location of a ring connected to the overlapping blades forming the funnel's wall (e.g. via mechanical rail) in an up-down move from the top of the funnel to change the funnel's wall angle. The set of blades that form the funnel's wall can be designed to operate as a dynamic compression system, wherein the Iris-Type diaphragm mechanism could be controlled by a sensor-based system operated by AI to adjust the wall's angle automatically via the incorporation of an electric motor.

I claim:

1. A system comprising multiple rotating and shape-adjustable funnel structures layered with metamaterial and/or metasurface materials with embedded surface sensors to generate different wavelengths as each funnel compress, stretch, or redirect incoming light wavelengths based on the geometry of the funnels and the sensors feedback to manipulate light in real time.

2. A system comprising multiple rotating and shape-adjustable funnel structures layered with metamaterial and/or metasurface materials with embedded surface sensors to generate different wavelengths as each funnel compress, stretch, or redirect incoming light wavelengths based on the geometry of the funnels and the sensors feedback and wherein the dynamic optical system manipulates light in real time and is operated by an AI algorithm to optimize funnel behavior for specific spectral outputs.

3. A system comprising multiple rotating and shape-adjustable funnel structures layered with metamaterial and/or metasurface materials with embedded surface sensors to generate different wavelengths as each funnel compress, stretch, or redirect incoming light wavelengths based on the geometry of the funnels and the sensors feedback and wherein the dynamic optical system manipulates light in real time and is operated by an AI algorithm to optimize funnel behavior for specific spectral outputs and wherein the rotation of a funnel creates centrifugal forces that influence light propagation, enable Doppler-like effects to shift wavelengths, and allow for angular momentum transfer to photons per optical vortex generation.
